(19) United States
(12) Patent Application Publication
(10) Pub. No.: US 2018/0174129 A1
(43) Pub. Date: Jun. 21, 2018

(54) Method and Apparatus for Processing Mobile Payment Using Blockchain Techniques

(71) Applicants: Christopher James Georgen, Kildeer, IL (US); Matthew Paul Kindy, II, Austin, TX (US); James Allen Aman, Houston, TX (US); Zihe Huang, San Francisco, CA (US)

(72) Inventors: Christopher James Georgen, Kildeer, IL (US); Matthew Paul Kindy, II, Austin, TX (US); James Allen Aman, Houston, TX (US); Zihe Huang, San Francisco, CA (US)

(73) Assignee: TOPL, LLC, Kildeer, IL (US)

(21) Appl. No.: 15/839,245

(22) Filed: Dec. 12, 2017

Related U.S. Application Data
(60) Provisional application No. 62/432,755, filed on Dec. 12, 2016.

(51) Int. Cl. G06Q 20/32; G06Q 20/40; H04W 4/021

(52) U.S. Cl. CPC G06Q 20/3224; G06Q 20/4012; G06Q 2220/00; G06Q 20/327; H04W 4/021; G06Q 20/325

(57) ABSTRACT

Presently disclosed are methods and devices for making secure payments from mobile devices. The methods and devices may be implemented, without limitation, for example in a retail setting, at a point of sale. Advancements disclosed herein include the establishment of a geo-fenced region surrounding the point of sale, systems for detecting the entry of a mobile device into the point of sale, communication channels between a mobile device positioned within the geo-fenced region and the point of sale as well as a back-end server, and the transmission and verification of PIN numbers from the mobile device. Additionally disclosure are method and devices for facilitating a transaction after verification

### PRIORITY CLAIM

This application claims the benefit of Provisional Application No. 62/432,755, filed on Dec. 12, 2016, which is incorporated herein by reference.

### BACKGROUND

### 1. Field of Invention

The present inventions relate to a method of contactless payment involving a mobile device. More specifically, the present inventions relate to apparatuses and methods by which an individual in possession of a mobile device, a user, can be identified and verified for the purchase of a payment transaction when located in a defined region in space.

### 2. Discussion of Prior Art

Over the last several years, there has been a great deal of interest in the development of mobile payments allowing shoppers to access payment instruments through use of their mobile phones. This has led to the proliferation of various technologies that purport to accomplish these ends while increasing security and shopper convenience.

Examples of prior art include devices and methods that use of near-field communication (NFC) technology and quick response (QR) codes. Such technologies often rely on shopper interaction with both a payment terminal and the shopper's mobile device in addition to the transmission of data between the user's device and the payment terminal.

### BRIEF SUMMARY

The present inventions address the prior art's shortcomings by removing both the transmission of information between mobile device and payment terminal as well as reducing the number of system components requiring physical interaction by the shopper. This results in fewer points of vulnerability in the payment process and reduces the length of payment time.

Prior art devices and methods (including, for example, US Patent Pub. 2014/0019367 A1) process payment information in a manner exemplified in FIG. 1. Such processes may involve the transmission of a shopper's payment or identifying information from their phone to the payment terminal through use of NFC or similar technology. Inherent in such a process is the necessity of either specialized encryption software or hardware. Otherwise, there exists a substantial security vulnerability through which a malicious party may eavesdrop on the transmission and extract the shopper's payment information.

Alternatively, other prior art disclosures (including, for example, US Patent 20150051993 A1) may bypass direct communication between payment terminal and shopper's device but nevertheless depend upon the transmission of sensitive payment or identifying information over cellular, WiFi, or other network connectivity, as seen in FIG. 2.

Accordingly, there is a need for methods and devices that operate without the security vulnerability inherent in passing sensitive information to or from a payment terminal or user's mobile device.

The present inventions allow for a person in possession of a suitable mobile device possessing a valid account or device identifier, such as a token, to pay at a business through a payment terminal by using pre-configured verification information, including but not limited to a Personal Identification Number (PIN), facial or another biometric signature, or a written signature. Additionally, the present inventions may not require any interaction between the user and his mobile device. Instead, all physical interaction occurs between the user or the operator of the payment terminal and the payment terminal. Moreover, in one or more embodiments, the present inventions may not require use of direct or indirect communication between the mobile device and payment terminal, thus removing a major potential attack vector for malicious actors.

### DESCRIPTION OF THE FIGURES

FIG. 1 is a diagram of the prior art process of mobile payment involving NFC or similar technology for direct communication between a shopper's device and a payment terminal. This figure depicts the transfer of encrypted or unencrypted identifying or payment information between the mobile device, 104, and the payment terminal, 102.

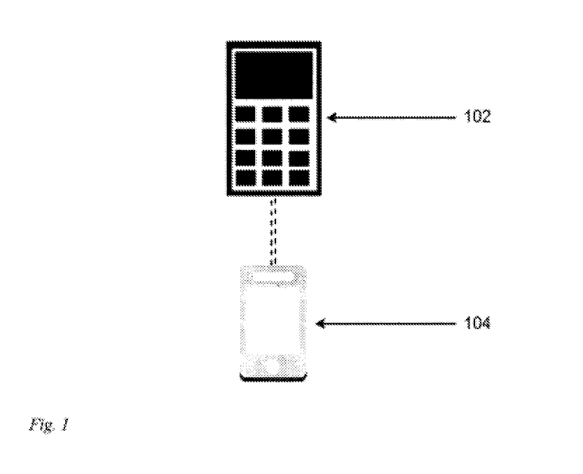

FIG. 2 is a diagram of the prior art process of mobile payment involving indirect communication between the mobile device, 104, and the payment terminal, 102, using cloud or otherwise remote server infrastructure, 206, as an intermediary. In such a process, identifying or payment information is transmitted indirectly between the devices involved.

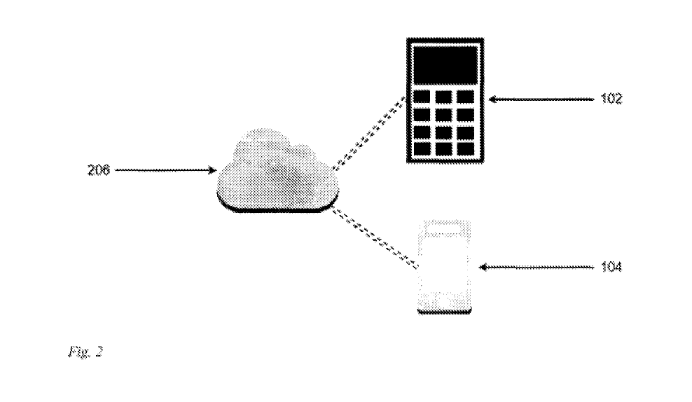

FIG. 3 is a diagram of the present inventions showing exemplary components and connection paths between a mobile device and a payment terminal.

FIG. 4 is a diagram of the present inventions showing exemplary components and connection paths between a plurality of mobile devices and a payment terminal and illustrates the potential for more than one mobile device (306, 408) to reside within the generated geo-fence, 302, with other mobile devices (410, 412) residing outside. In such an event, only mobile phones within the geo-fenced region will notify the remote server, 300, of their presence in such a location. Therefore, only verification information corresponding to mobile devices, 306 and 408 would be accepted as valid at time of transaction.

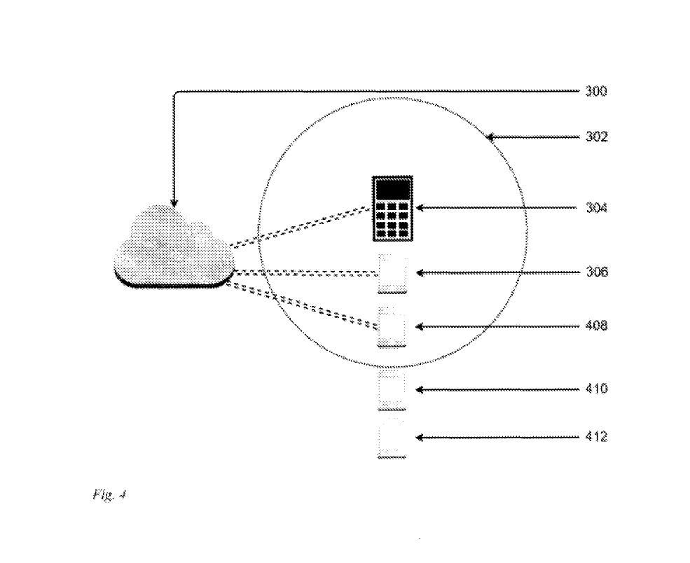

### DETAILED DESCRIPTION

Set forth below is a description of what are currently believed to be the preferred embodiments or best representative examples of the inventions claimed. Present and future modifications to the embodiments and preferred embodiments are contemplated. Any alterations or modifications which make insubstantial changes in function, purpose, structure, or result are intended to be covered by the claims of this patent.

Some embodiments of the inventions use geo-fenced regions 302 for the purpose of determining the location of a user's mobile device. Geo-fenced regions 302 can be created and maintained either by the use of absolute coordinates corresponding to the expected location of the payment terminal 304, or by use of a Bluetooth signal or similar signal produced by the payment terminal or one or more co-located signal generators to determine the distance between a user's mobile device and the payment terminal 304. Detection of such geo-fenced regions acts as the trigger for mobile devices with valid account or device identifiers to contact the remote server, 300.

In one of more embodiments of the inventions, the geo-fencing signal is created by a Bluetooth signal generating device. Such a device may be produced by Estimote, Inc., Radius Networks, Inc., or any number of competitors and may use Texas Instruments' TI CC254x, Nordic Semiconductor's nRF51822, or a similar chipset to produce the Bluetooth signal. This signal generator may be located within one (1) meter or less of the payment terminal. The produced signal may be detected by the user's mobile device through an integrated Qualcomm Snapdragon modem, or similar modem or chipset. The detection of such a signal or Bluetooth connection to the signal generating device along with the identifier associated with this signal may then be communicated by the mobile device to a remote server, 300, through WiFi or cellular connections.

In one or more embodiments of the inventions the geo-fenced region may generated by use of location coordinates determined through interaction with one or more Global Navigation Satellite Systems. In such embodiments, co-location of the mobile device and payment terminal may be determined by both devices reporting sufficiently similar location coordinates, for example location coordinates within 20 meters or less. The location coordinates may be determined using Qualcomm iZat, or similar, location technology available on the chipset of the mobile device or payment terminal. The location coordinates may then be communicated by the mobile device and payment terminal to a remote server, 300, through WiFi or cellular connections.

In one or more embodiments of the inventions the geo-fenced region may be generated by use of WiFi networks. In such embodiments, co-location of the mobile device and payment terminal may be determined by comparison of the IP address of each device. In the event that both devices report IP addresses from the same WiFi network then the two devices will be determined to be co-located. Alternatively, co-location using WiFi networks may be determined using Qualcomm iZat, or similar, location technology available on the chipset of the mobile device or payment terminal. The location coordinates may then be communicated by the mobile device and payment terminal to a remote server, 300, through WiFi or cellular connections.

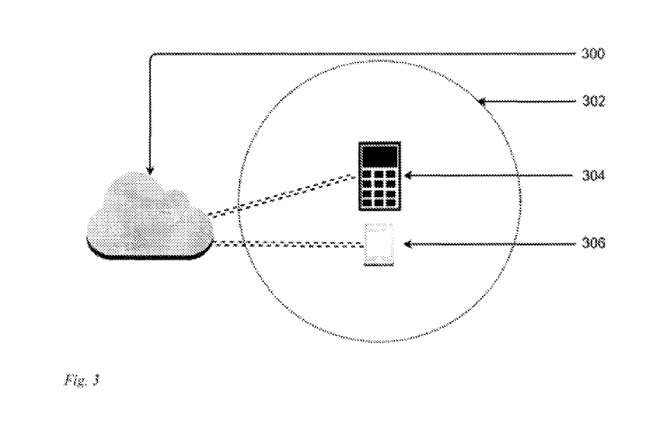

For example, FIG. 3 illustrates the presence of a mobile device with valid account or device identifier, 306, within the geo-fenced region, 302, associated with the payment terminal, 304. When such a mobile device is within the geo-fenced region, a connection is established between that mobile device and the remote server, 300. Once the mobile device, 306, is recognized by the remote server, 300, as being within the geo-fenced region, 302, the verification information associated with the device's identifier is added to the server's list of verification data that will be considered valid for that payment session.

In embodiments of the inventions, mobile devices with valid account or device identifiers (306, 308, 410, 412) respond to the presence of a geo-fenced region, 302, by informing the remote server, 300, of the identity of that particular region and the device's presence within that region. Such detection of the geo-fenced region may occur through use of Bluetooth, GPS, WiFi or other means of location or communication available to the device. For this purpose, the user's mobile device may include a transceiver module that may interact with the geo-fence.

A payment terminal, 304, is associated with a geo-fenced region, 302. As described above, the geo-fenced region may be established surrounding the payment terminal using either the terminal itself or signal generators located nearby. In embodiments of the inventions, the edges of a geo-fence may be a meter from the payment terminal.

In embodiments of the inventions, after a mobile device informs the remote server of its presence within a geo-fenced region, 302, the server may trigger the mobile device to generate a signal that may be detected by a nearby payment terminal and passed to the remote server, 300. This signal may be emitted by a Qualcomm Snapdragon, or competitor equivalent, modem and may include a shared secret, such as a symmetric or public-private key pair that the server may use to verify the identity of the mobile device.

In embodiments of the inventions, after a mobile device has entered a geo-fenced region it may continue to verify, via continued monitoring of the generated Bluetooth signal, that it is still within the geo-fenced region. Upon exiting the region, the mobile device may inform the remote server that it is no longer within the geo-fenced region.

In one or more embodiments of the invention the user's mobile device may lack the ability to communicate with the remote server. In such embodiments, the mobile device may detect the geo-fenced region and may then encrypt the identifier of such region along with its associated account token or other identifying information and broadcast this information via a Bluetooth signal generated by a Qualcomm Snapdragon, or competitor equivalent, modem. This signal may be detected by the payment terminal's Bluetooth enabled chipset or modem and be transmitted to the remote server. The passage of such information between mobile device and payment terminal may include a shared secret, such as a symmetric or public-private key pair that the server may use to verify the identity of the mobile device.

The remote server, 300, receives and makes use of information from mobile devices and payment terminals, stores information related to accounts and geo-fenced regions, and acts to approve or reject transactions as well as any modifying or appended information. As such, the mobile device may include memory which stores a token or account or device identifier wherein such an identifier is transmitted to the remote server upon the mobile device entering the geo-fenced region. Additionally, the payment terminal may include memory which stores a token or account or device identifier wherein such an identifier is included in the broadcast of the geo-fence signal wherein such an identifier is transmitted by the mobile device to the remote server upon the former's entrance into the geo-fenced region.

Moreover, the remote server may contain real-time lists of the identifiers of mobile devices currently located within a geo-fenced region. A real-time list may be stored in a database and may consist of the account or device identifiers of the mobile devices that have reported to be within a geo-fenced region wherein these devices have not yet reported leaving the region or these devices have been within the region for less than a defined length of time.

In embodiments of the inventions, after a mobile device has entered a geo-fenced region, the user may be prompted to enter a PIN or other another authorizing piece of information into the payment terminal to confirm his identity. The payment terminal may send this information to the remote server. The remote server then rejects or confirms the initialization of a session based upon whether or not the provided PIN corresponds to a mobile device located within the gee-fenced region of the payment terminal that provided the PIN to the remote server. Such a confirmation or rejection may be returned to the payment terminal for display to the operator and user.

In embodiments of the inventions, upon initialization of a session, the remote server may send additional information to the payment terminal relating to the identity or account of the user associated with such a session. This may include information related to potential transaction modifiers including but not limited to discounts, rewards, or promotions. This information may be displayed to the user through the payment terminal and can be accepted or declined by the user or operator.

In the course of a payment session, information may be input into the payment terminal and sent to the remote server. This information may include the amount of the payment, the acceptance of transaction modifiers such as those described for example in the preceding paragraph and elsewhere herein, and confirmation of the proposed transaction.

In embodiments of the inventions, upon the completion of a payment session the remote server may update the relevant user's account to reflect a modified balance as well as to include a quantity of points that can be used towards the redemption of discounts, free items, or other promotions as described further herein.

By way of non-limited example, four exemplary payment processes using embodiments of the inventions are detailed in the following paragraphs. For example, a user, who has sufficient funds in his account and provides the correct verification information, may attempt to make a payment using the methods and devices disclosed herein:

1. User's mobile device, 306, enters the geo-fenced region, 302, of the payment terminal, 304, at which the transaction will occur. Entry to the geo-fenced region is detected by the mobile device 306.

2. User's mobile device, 306, communicates with the remote server, 300, indicating that it is within the geo-fenced region of the payment terminal, 304. This communication may occur over WiFi or cellular network. Moreover, the communication may include sending account or device identifiers for the mobile device and payment terminal, as described above.

3. Remote server, 300, adds the user's device to the list of mobile devices in the geo-fenced region of the payment terminal, 304.

4. User provides a pre-configured PIN to the payment terminal, 304, which is then sent to the remote server, 300.

5. Remote server, 300, confirms that the provided PIN corresponds with the account of a mobile device, 306, within the geo-fenced region, 302.

6. Payment amount is input into the payment terminal, 304, and the amount, less any available and selected discounts, is sent to the remote server, 300 to check if the account associated with the payment session has a sufficient balance.

7. Confirmation of sufficient balance is returned to payment terminal, 304.

8. Shopper confirms the transaction with the payment terminal, 304.

9. Final transaction information is sent to remote server, 300, which updates transaction history and account and point balances accordingly.

For example, a user, who has insufficient funds in his account but provides the correct verification information, may attempt to make a payment using the methods and devices disclosed herein:

1. User's mobile device, 306, enters the geo-fenced region, 302, of the payment terminal, 304, at which the transaction will occur. Entry to the geo-fenced region is detected by the mobile device 306.

2. User's mobile device, 306, communicates with the remote server, 300, indicating that it is within the geo-fenced region of the payment terminal, 304. This communication may occur over WiFi or cellular network. Moreover, the communication may include sending account or device identifiers for the mobile device and payment terminal, as described above.

3. Remote server, 300, adds the user's device to the list of mobile devices in the geo-fenced region of the payment terminal, 304.

4. User provides a pre-configured PIN to the payment terminal, 304, which is then sent to the remote server, 300.

5. Remote server, 300, confirms that the provided PIN corresponds with the account of a mobile device, 306, within the geo-fenced region, 302.

6. Payment amount is input into the payment terminal, 304, and the amount, less any available and selected discounts, is sent to the remote server, 300 to check if the account associated with the payment session has a sufficient balance.

7. Message of insufficient balance is returned to payment terminal, 304, and payment session is terminated as unsuccessful by the remote server.

For example, a user, who provides incorrect verification information, may attempt to make a payment using the methods and devices disclosed herein:

1. User's mobile device, 306, enters the geo-fenced region, 302, of the payment terminal, 304, at which the transaction will occur. Entry to the geo-fenced region is detected by the mobile device 306.

2. User's mobile device, 306, communicates with the remote server, 300, indicating that it is within the geo-fenced region of the payment terminal, 304. This communication may occur over WiFi or cellular network. Moreover, the communication may include sending account or device identifiers for the mobile device and payment terminal, as described above.

3. Remote server, 300, adds the user's device to the list of mobile devices in the geo-fenced region of the payment terminal, 304.

4. User provides a pre-configured PIN to the payment terminal, 304, which is then sent to the remote server, 300.

5. Remote server, 300, rejects incorrect verification information.

6. Notice of failed verification is sent to payment terminal, 304, and user is prompted to enter correct verification information.

For example, a malicious actor, who provides verification information not associated with a mobile device located within the geo-fenced region, may attempt to make a payment using the methods and devices disclosed herein:

1. Actor provides verification information to the payment terminal, 304, which is then sent to the remote server, 300.

2. Remote server, 300, rejects invalid verification information.

3. Notice of failed verification is sent to payment terminal, 304, and actor is prompted to enter the verification information corresponding to a mobile device located with the geo-fenced region, 302.

While the description above disclosed particular embodiments of the inventions, it should be understood that any of the features of any of the embodiments of the present disclosure may be combined with any features of other embodiments of the present disclosure.

It will be appreciated by those skilled in the art that while the invention has been described above in connection with particular embodiments and examples, the invention is not necessarily so limited, and numerous other embodiments, examples, uses, modifications and departures from the embodiments, examples and uses are intended to be encompassed by the claims attached hereto.

What is claimed:

1. A system for securely processing transactions, comprising:
a payment terminal in operable communication with a remote server;
a geo-fenced region associated with the payment terminal;
a mobile device configured to detect the mobile device's entry into the geo-fenced region; wherein the mobile device is further configured to send an identifier to the remote server upon entry into the geo-fenced region.

2. The system for securely processing transactions of claim 1, wherein the remote server is configured to receive the identifier from the mobile device and add the identifier to a memory storing a list of all mobile devices within the geo-fenced region.

3. The system for securely processing transactions of claim 2, wherein the payment terminal is further configured to store, in a memory, a token, wherein such token is included in a broadcast of a geo-fence signal transmitted to the mobile device.

4. The system for securely processing transactions of claim 3, wherein the payment terminal is further configured to receive a PIN inputted by a user, and, upon receiving the PIN, confirms that the PIN corresponds with the account of the mobile device within the geo-fenced region.

5. The system for securely processing transactions of claim 4, wherein the mobile device and the remote server are in wireless communication using a WiFi or cellular network.

6. A method for securing a transaction, comprising the steps of:
establishing a geo-fenced region associated with a payment terminal, wherein the payment terminal is in communication with a remote server;
placing a mobile device within the geo-fenced region, wherein the mobile device includes a chipset for detecting the geo-fenced region;
transmitting an identifier from the mobile device to the payment terminal and the remote server;
at the remote server, maintaining, on a memory, a list of mobile devices within the geo-fenced region and, upon receiving the transmitted identified from the mobile device, adding the identifier to the list;
receiving, at the payment terminal, a user-provided PIN and sending said user-provided PIN to the remote server; and
using the remote server, confirming that the user-provided PIN corresponds with an account of the mobile device.

7. The method for securing a transaction of claim 6, wherein the step of establishing a geo-fenced region is performed using a Bluetooth signal generating device.

8. The method for securing a transaction of claim 7, wherein the mobile device includes a modem for detecting the geo-fenced region.

9. The method for securing a transaction of claim 8, wherein the modem is a Qualcomm Snapdragon modem.
